(19) United States
(12) Patent Application Publication
(10) Pub. No.: US 2012/0326418 A1
(43) Pub. Date: Dec. 27, 2012

(54) STROLLER

(75) Inventor: Ichiro Ohnishi, Nara-shi (JP)

(73) Assignee: Aprica Children's Products Inc., Osaka (JP)

(21) Appl. No.: 13/524,451

(22) Filed: Jun. 15, 2012

(30) Foreign Application Priority Data
Jun. 27, 2011 (JP) 2011-141626

(51) Int. Cl. B62B 7/04; B62B 7/06

(52) U.S. Cl. 280/642; 280/658

(57) ABSTRACT

A stroller includes: a pair of front legs; a pair of rear legs ; a frame main body that couples the front leg to the rear leg; a pair of push bars each extending in a vertical direction, attached to a front-leg member via a pivot shaft at a position above the lower end of the push bar, and capable of being selectively switched between a forward-facing position and a rear-facing position by pivoting about the pivot shaft in a longitudinal direction of the stroller; and an engaging unit that selectively engages a lower end region of the push bar, namely a portion of the push bar which is located below the pivot shaft, with the front-leg member or a rear-leg member.

### TECHNICAL FIELD

The present invention relates to reversible strollers having a push bar and capable of being switched between a forward-facing mode and a rear-facing mode by switching the push bar between front and rear positions.

### BACKGROUND ART

Many reversible strollers are known in the art in which a push bar extending upward from a frame main body of the stroller is pivotally supported by the frame main body via a pivot shaft, and which can be switched between a forward-facing mode and a rear-facing mode by switching the position of the push bar. As used herein, the “forward-facing mode” or the “forward-facing position” refers to a mode or position in which the operator pushes the stroller with a child facing forward, and the “rear-facing mode” or the “rear-facing position” refers to a mode or position in which the operator pushes the stroller with a child facing rearward. As described in, e.g., Japanese Unexamined Patent Application Publication Nos. 2010-234988, 2008-254688, 2008-254693, and 2002-284015, the conventional reversible strollers are typically configured so that the push bar is pivotally supported at its lower end by the frame main body, and pivots about the pivot point to a rear position or a front position. Such reversible strollers also have a handle portion at the upper end of the push bar. The push bar is a part longer than the frame main body, and the handle portion is located at an appropriate position both in the vertical (height) direction and the longitudinal direction of the stroller so that an operator can easily hold the handle portion. Thus, when switching the stroller to the forward-facing mode, the push bar is shifted to the rear position, and the position of the handle portion with respect to rear legs is determined. When switching the stroller to the rear-facing mode, the push bar is shifted to the front position, and the position of the handle portion with respect to front legs is determined.

### SUMMARY OF INVENTION

In Japanese Unexamined Patent Application Publication Nos. 2010-234988, 2008-254688, 2008-254693, and 2002-284015, the frame main body is an assembled body that couples the upper ends of the front legs to the upper ends of the rear legs to support a seat portion on which an infant or a small child is seated. The push bar is a long member extending to protrude upward from the frame main body. In Japanese Unexamined Patent Application Publication Nos. 2010-234988, 2008-254688, 2008-254693, and 2002-284015, the pivot point provided at the lower end of the push bar is provided near the rear leg for convenience of layout.

Such conventional strollers have the following problems because the pivot point of the push bar is located rearward of the longitudinal center of the frame main body. Firstly, when the push bar is shifted to the rear position (the forward-facing position) to switch the stroller to the forward-facing mode, the handle portion at the upper end of the push bar is located at an appropriate position both in the vertical (height) direction and the longitudinal direction of the stroller. Even if the stroller is thus designed so that the handle portion is located at an appropriate position with respect to the rear legs when the push bar is located at the forward-facing position, the vertical (height) or longitudinal position of the handle portion is changed if the push bar is pivoted forward about the pivot point to the front position (the rear-facing position) to switch the stroller to the rear-facing mode. Accordingly, when the push bar is located at the rear-facing position, the handle portion is not located at an appropriate position with respect to the front legs, thereby making the operator feel uncomfortable with the height of the handle portion. Moreover, the operator's toe tends to interfere with the front wheels. Thus, there is room for improvement in usability.

Secondly, the stroller includes a push-bar lock mechanism that holds the push bar in the forward-facing position or the rear-facing position by engaging with a portion of the push bar which is located above the pivot shaft located at the lower end of the push bar, and the push-bar lock mechanism is provided on the frame main body. Specifically, the push-bar lock mechanism is provided on an armrest extending in the longitudinal direction of the stroller. This is because the region where the push bar overlaps the frame main body is limited to the armrest for convenience of layout of the frame main body. In this case, when the operator performs a lifting operation of applying a downward force to the handle portion of the push bar to lift the wheel located farther from the push bar by using the wheel located closer to the push bar as a fulcrum, a large force is applied to the armrest and the frame main body, causing backlash of the frame main body. Thus, there is room for improvement in rigidity.

In view of the above problems, it is a first object of the present invention to provide a stroller that not only allows a push bar in a forward-facing position to be located at an optimal position for an operator, but also allows the push bar to be located at an optimal position for the operator even when the push bar is switched to the rear-facing position. It is a second object of the present invention to provide a reversible stroller capable of preventing backlash of a frame main body and having high rigidity.

In order to achieve the above objects, a stroller according to the present invention includes: a pair of front-leg members each having a front wheel at its lower end; a pair of rear-leg members each having a rear wheel at its lower end; a frame main body that couples an upper end of the front-leg member to an upper end of the rear-leg member; a push bar extending in a vertical direction, attached to the frame main body, the front-leg member, or the rear-leg member via a pivot shaft at a position above a lower end of the push bar, and capable of being selectively switched between a forward-facing position and a rear-facing position by pivoting about the pivot shaft in a longitudinal direction of the stroller; and an engaging unit that selectively engages a lower end region of the push bar, namely a portion of the push bar which is located below the pivot shaft, with the front-leg member or the rear-leg member.

According to the present invention, the pivot shaft of the push bar is provided at a position above the lower end region of the push bar. This allows the pivot shaft of the push bar to be easily placed in a longitudinal central portion of the frame main body in terms of layout. Thus, the above first object is achieved, and the push bar, which is located at an appropriate position for the forward-facing mode when in the forward-facing position, can be located at an appropriate position for the rear-facing mode even if the push bar is switched to the rear-facing position.

It should be understood that the push bar attached to the frame main body via the pivot shaft at the position above the lower end of the push bar refers to the push bar having the pivot shaft provided at one position in a longitudinal region of the push bar excluding the lower end of the push bar and including a vertical central portion of the push bar. More preferably, the pivot shaft of the push bar is provided in a region located below the vertical center of the push bar and excluding the lower end of the push bar. It should be understood that the lower end region of the push bar refers to the region located below the vertical center of the push bar, and includes the lower end of the push bar. Accordingly, if the push bar is switched from the forward-facing position to the rear-facing position, the upper and lower ends of the push bar, which are located opposite from each other with the pivot shaft interposed therebetween, are reversed in longitudinal position.

The lower end region of the push bar, which is engaged with the front-leg member or the rear-leg member by the engaging unit, may be either a region located closer to the pivot shaft or a region located closer to the lower end of the push bar, but is preferably the lower end of the push bar. This allows a force that is applied to the push bar to be easily transmitted to the front-leg member or the rear-leg member when the operator performs a lifting operation of applying a downward force to the upper end of the push bar to lift the front wheel or the rear wheel.

Although a configuration of holding the push bar in the forward-facing position and a configuration of holding the push bar in the rear-facing position are not particularly limited, the engaging unit preferably includes a push-bar lock mechanism that engages the lower end of the push bar with the front-leg member to hold the push bar in the forward-facing position, and that engages the lower end of the push bar with the rear-leg member to hold the push bar in the rear-facing position. According to this embodiment, the lower end of the push bar which is located below the pivot shaft is selectively engaged with the frame main body or the rear leg. Alternatively, the lower end of the push bar which is located below the pivot shaft is selectively engaged with the front leg or the rear leg. As a result, the above second object is achieved. That is, when the operator performs a lifting operation of lifting the wheel located farther from the push bar by using the wheel located closer to the push bar as a fulcrum, a force that is applied from the operator to the upper end of the push bar is directly transmitted to the front leg or the rear leg via the push bar. Thus, no force is applied to the arm rest, and the force that is applied to the frame main body can be reduced. This reduces backlash and improves rigidity, thereby improving durability performance of the stroller.

The configuration of the push-bar lock mechanism is not particularly limited. As an embodiment, the push-bar lock mechanism may have an engaging member provided on the lower end of the push bar and capable of being displaced in a direction in which the push bar extends, and an engaged member provided on each of the front-leg member and the rear-leg member to engage with the engaging member. According to this embodiment, since the push-bar lock mechanism has the engaging member provided on the lower end of the push bar and capable of being displaced in a direction different from a pivoting direction of the push bar. Thus, the engaging member can securely engage with the engaged member so that the push bar does not pivot, whereby the push bar can be held in the forward-facing position or the rear-facing position. When switching the position of the push bar, the push bar can be easily unlocked by displacing the engaging member. Moreover, the engaged member can be easily reengaged with the engaging member on the lower end of the push bar. Thus, the push-bar lock mechanism can be automatically and easily operated or released, whereby usability is improved.

The front wheel and the rear wheel of the present invention may be wheels incapable of changing their directions, but are preferably casters capable of changing their directions. As a preferred embodiment, the engaging unit includes a push-bar member provided on the lower end of the push bar, a front-leg-side movable member that is displaceably provided on the front-leg member and that engages with the push-bar member when the push bar is shifted to the forward-facing position, and a rear-leg-side movable member that is displaceably provided on the rear-leg member and that engages with the push-bar member when the push bar is shifted to the rear-facing position. The front wheel and the rear wheel are casters capable of changing their directions. The stroller further includes: a front-caster mechanism having a caster holding member that is provided on the lower end of the front-leg member, and a caster pivot member that is held by the caster holding member so as to be pivotable about a rotation axis extending in the vertical direction and that shaft-supports the front wheel; a rear-caster mechanism having a caster holding member that is provided on the lower end of the rear-wheel member, and a caster pivot member that is held by the caster holding member so as to be pivotable about a rotation axis extending in the vertical direction, and that shaft-supports the rear wheel; a front-caster lock mechanism having a front-caster lock member that is provided on the caster holding member of the front wheel, and that, when located at a first position, engages with the caster pivot member of the front wheel to restrict pivoting of the caster pivot member, and when located at a second position, is separated from the caster pivot member of the front wheel to allow the caster pivot member to pivot; a rear-caster lock mechanism having a rear-caster lock member that is provided on the caster holding member of the rear wheel, and that, when located at a first position, engages with the caster pivot member of the rear wheel to restrict pivoting of the caster pivot member, and when located at a second position, is separated from the caster pivot member of the rear wheel to allow the caster pivot member to pivot; a front-leg link mechanism that connects the front-caster lock member with the front-leg-side movable member of the engaging unit; and a rear-leg link mechanism that connects the rear-caster lock member with the rear-leg-side movable member of the engaging unit.

According to this embodiment, the stroller includes the front-caster lock mechanism that allows the front wheel to change its direction with the front leg being engaged with the lower end of the push bar, and the rear-caster lock mechanism that allows the rear wheel to change its direction with the rear leg being engaged with the lower end region of the push bar. This allows the wheel located on the front side in the traveling direction to change its direction, and does not allow the wheel located on the rear side in the traveling direction to change its rotation, according to whether the push bar is located at the forward-facing position or the rear-facing position. In the forward-facing mode, the wheel located on the front side in the traveling direction is the front wheel, and the wheel located on the rear side in the traveling direction is the rear wheel. In the rear-facing mode, the wheel located on the front side in the traveling direction is the rear wheel, and the wheel located on the rear side in the traveling direction is the front wheel.

According to this embodiment, the front-leg link mechanism is provided only in the front-leg member, and is not provided in the frame main body. The rear-leg link mechanism is provided only in the rear-leg member, and is not provided in the frame main body. The front-leg link mechanism is configured separately from the rear-leg link mechanism. This contributes to simplification and reduction in size as compared to a conventional front-caster lock mechanism in which a first wire is placed to extend from the front leg to the push bar via the frame main body, a second wire is placed to extend from the rear leg to the push bar via the frame main body, and the first and second wires are coupled together as described in Japanese Unexamined Patent Application Publication No. 2010-234988.

The stroller of the present invention does not necessarily have a foldable structure, but is preferably foldable into a small folded configuration.

As an embodiment, the front-leg member includes a front leg having the front wheel at its lower end, and a slide member attached so as to be slidable along the front leg, and the push bar is attached to the slide member via a pivot shaft, and is shifted to a folded position by sliding downward from the forward-facing position. According to this embodiment, the stroller is reduced in size in the vertical direction when folded. Thus, the stroller can be stored in a compact form when not in use.

As a preferred embodiment, the front-leg member includes a front leg having the front wheel at its lower end, and a slide member attached so as to be slidable along the front leg, the push bar is attached to the slide member via a pivot shaft, and the push bar is shifted to a folded position by sliding downward from the forward-facing position, and the push-bar member of the engaging unit is disengaged from both the front-leg-side movable member and the rear-leg-side movable member. According to this embodiment, since the stroller is reduced in size in the vertical direction when folded, the stroller can be stored in a compact form when not in use. Moreover, since the lower end region of the push bar is separated from both caster lock mechanisms, the front wheel and the rear wheel are not allowed to change their directions. Thus, the front wheel and the rear wheel of the stroller do not accidentally rotate in the folded state, whereby stability during storage of the stroller is improved.

The stroller of the present invention is preferably foldable into a smaller folded configuration. As an embodiment, the stroller may further include: a longitudinal member extending in the longitudinal direction, having its front end coupled to the slide member via a pivot shaft, and having its rear end coupled to the rear leg via a pivot shaft, and the rear leg may have its upper end coupled to the frame main body via a pivot shaft, and may be shifted to a folded position by pivoting forward about the pivot shaft in the upper end of the rear leg. According to this embodiment, the stroller is reduced in size in the vertical and longitudinal directions when folded. Thus, the stroller can be stored in a more compact form when not in use.

The push bar may or may not contact the ground in the folded state. Preferably, the stroller stands by itself in the folded state with at least one of a lower end of the slide member and the lower end of the push bar in the folded position being in contact with the ground, and with at least one of the front wheel and the rear wheel being in contact with the ground. According to this embodiment, since at least one of the lower end of the slide member and the lower end of the push bar and at least one of the front wheel and the rear wheel contact the ground, the stroller can stand by itself in the folded state. This can reduce the area of a storage place.

As described above, the stroller according to the present invention not only allows the push bar in the forward-facing position to be located at an optimal position for the operator, but also allows the push bar to be located at an optimal position for the operator even when the push bar is switched to the rear-facing position. This facilitates pushing of the stroller not only in the forward-facing mode but also in the rear-facing mode. Moreover, backlash of the frame main body is prevented, and rigidity is improved. The force that is applied to the frame main body in the lifting operation can be reduced.

### BRIEF DESCRIPTION OF DRAWINGS

FIG. 1 is a side view schematically showing a stroller according to an embodiment of the present invention in a forward-facing mode.

FIG. 2 is a side view schematically showing the stroller of the embodiment in a rear-facing mode.

FIG. 3 is a side view showing the stroller in the folding process.

FIG. 4 is a side view showing the stroller in a folded state.

FIG. 5 is a side view showing a push-bar lock mechanism.

FIG. 6 is a front view showing a push bar, a rear leg, the push-bar lock mechanism, and a rear-caster lock mechanism.

FIG. 7 is a front view showing the push bar and the push-bar lock mechanism.

FIG. 8 is a diagram showing an engaging member of the push-bar lock mechanism.

FIG. 9 is a schematic view showing a caster as viewed from above.

FIG. 10 is a schematic view showing the caster as viewed laterally.

FIG. 11 is a front view corresponding to FIG. 7, showing a front leg and a front-caster lock mechanism.

FIG. 12 is a front view showing the front leg and the front-caster lock mechanism.

FIG. 13 is a cross-sectional view taken along one-dotted chain line XIII-XIII in FIG. 2, as viewed from the direction of arrows of the chain line XIII-XIII.

### DESCRIPTION OF EMBODIMENTS

An embodiment of the present invention will be described in detail below with reference to the accompanying drawings.

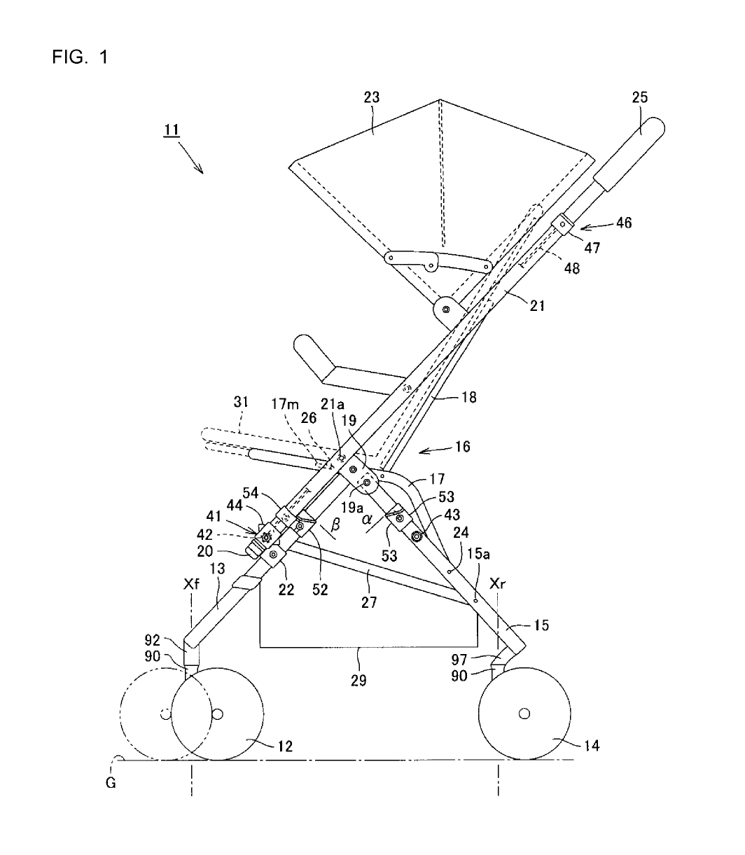

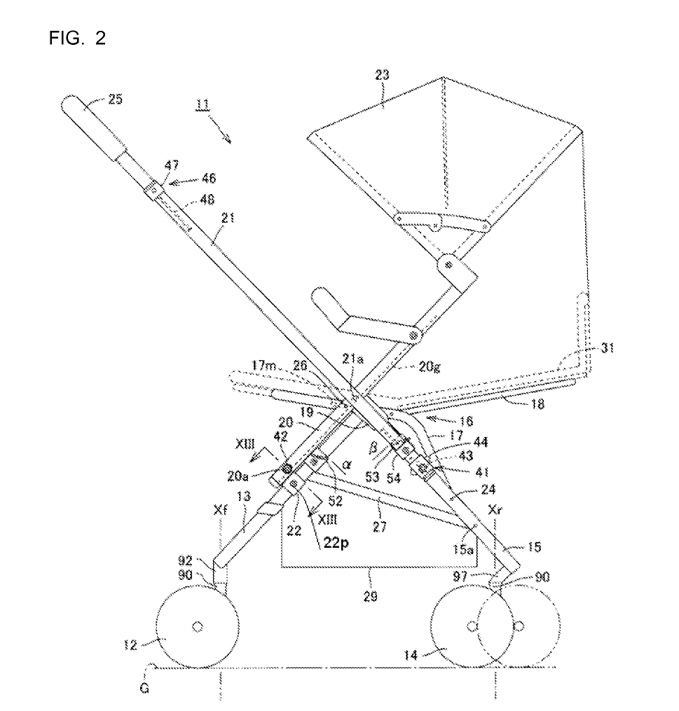

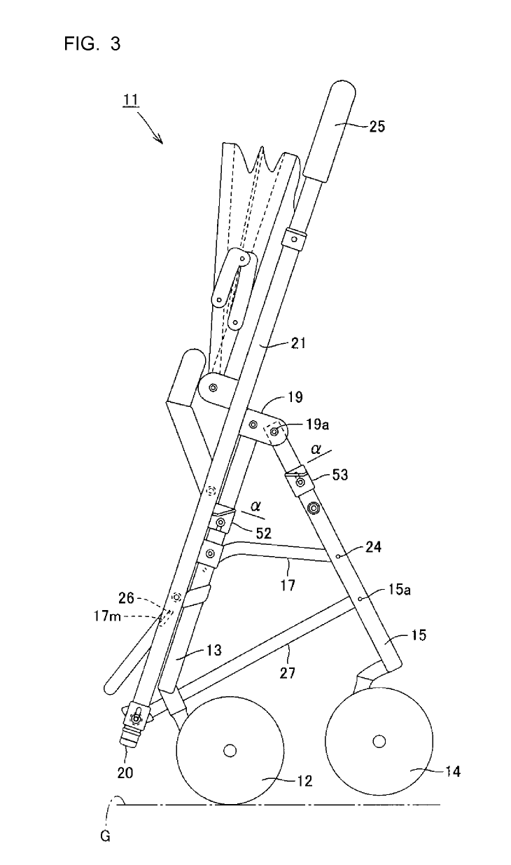

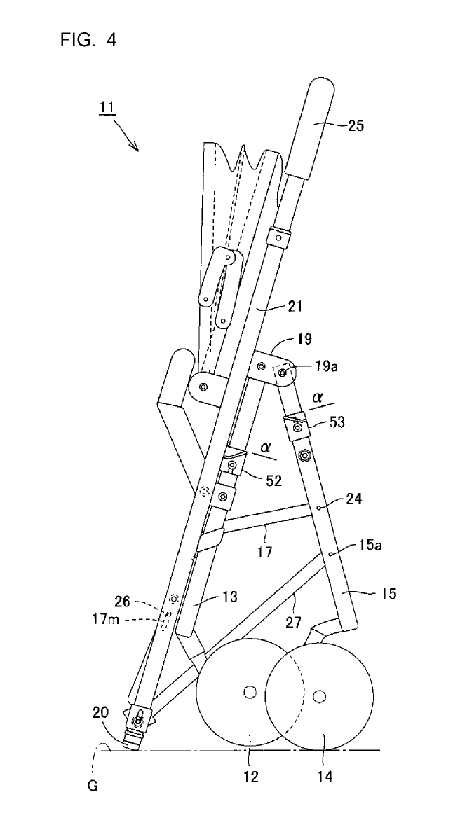

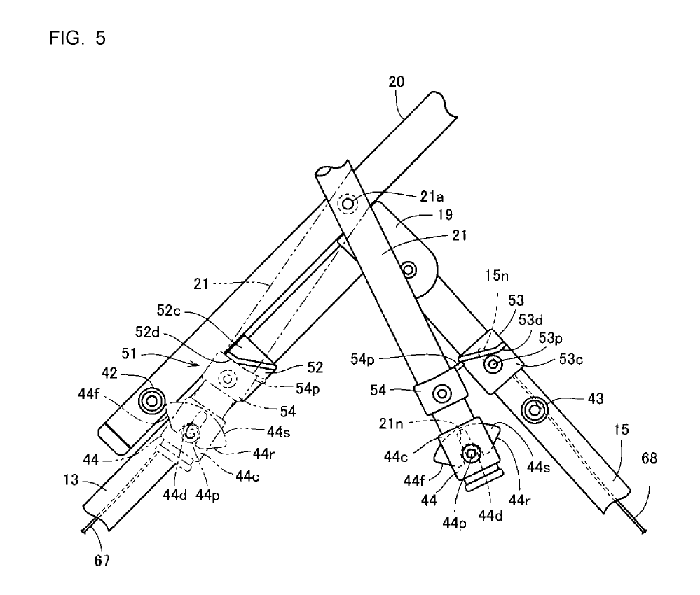

FIG. 1 is a side view schematically showing a stroller according to an embodiment of the present invention in a forward-facing mode. FIG. 2 is a side view schematically showing the stroller of the embodiment in a rear-facing mode. FIGS. 1 and 2 show the stroller in a deployed state. FIG. 3 is a side view showing the stroller in the folding process, and FIG. 4 is a side view showing the stroller in a folded state. The stroller can be folded into such a compact folded configuration when not in use. FIG. 5 is a side view showing a push-bar lock mechanism. FIGS. 1 to 5 show the stroller as viewed from the left side in the lateral direction of the stroller. The left side in FIGS. 1 to 5 shows the forward direction, and the right side in FIGS. 1 to 5 shows the rearward direction, as defined in the stroller in the forward-facing mode.

A stroller 11 includes a pair of front legs 13 each having a front wheel 12 at its lower end, a pair of rear legs 15 each having a rear wheel 14 at its lower end, a frame main body 16 coupling the upper ends of the front legs 13 to the upper ends of the rear legs 15, and a pair of push bars 21 each extending in the vertical direction, attached to the frame main body 16 via a pivot shaft, and capable of being selectively switched between a forward-facing position and a rear-facing position by pivoting about the pivot shaft in the longitudinal direction. The front legs 13 are included in a front-leg member, and the rear legs 15 are included in a rear-leg member.

The pair of front legs 13 are provided on the left and right sides in the lateral direction of the stroller 11, respectively, and each front leg 13 extends obliquely in the vertical direction with its lower end facing forward and its upper end facing rearward. The pair of rear legs 15 are provided on the left and right sides in the lateral direction of the stroller 11, and each rear leg 15 extends obliquely in the vertical direction with its lower end facing rearward and its upper end facing forward. Each front leg 13 is provided with the front wheel 12, and each rear leg 15 is provided with the rear wheel 14. Although the wheels 12, 14 have a double-wheel structure having two wheels per leg, the wheels 12, 14 may have a single-wheel structure. A storage basket 29, comprised of a bendable material such as fabric, is attached to the four legs, namely the front legs 13 and the rear legs 15.

When the push bars 21 are located at the forward-facing position, the front legs 13 and the front wheel 12 are located on the front side, and the rear legs 15 and the rear wheels 14 are located on the rear side in the traveling direction of the stroller 11. However, when the push bars 21 are located at the rear-facing position, the front legs 13 and the front wheel 12 are located on the rear side, and the rear legs 15 and the rear wheels 14 are located on the front side in the traveling direction of the stroller 11.

The frame main body 16 is formed by a plurality of frame members and a coupling element that couples the frame members together, and supports a child seat 31. Specifically, the frame main body 16 includes a pair of seat-portion support members 17 that support a seat portion of the child seat 31, a pair of backrest-portion support members 18 that support a backrest portion of the child seat 31, and a pair of central coupling members 19 that couple the upper ends of the front legs 13 to the upper ends of the rear legs 15, respectively. The pair of seat-portion support members 17, the pair of backrest-portion support members 18, and the pair of central coupling members 19 are placed symmetrically in the lateral direction of the stroller 11.

The seat-portion support member 17 is a pipe generally extending substantially in the longitudinal direction and being bent at its central portion so that a rear end region of the pipe extends obliquely downward. The rear end of the seat-portion support member 17 is pivotally coupled to an intermediate region of the rear leg 15 via a pivot shaft 24. The seat portion of the child seat 31 is attached to a front end region of the seat-portion support member 17. A long hole 17m is formed in the front end region of the seat-portion support member 17. A pivot shaft 26 extends through the long hole 17m. The pivot shaft 26 is fixed to a slide member 20.

The backrest-portion support member 18 is a pipe extending substantially in the vertical direction. The lower end of the backrest-portion support member 18 is coupled to the central portion of the seat-portion support member 17 via a pivot shaft. The backrest-portion support member 18 pivots in the longitudinal direction about this pivot shaft to allow the child seat 31 to recline.

The central coupling member 19 is a member having two opposing sidewall portions, and a shaft portion and a dovetail portion which couple the two sidewall portions together. The upper end of the rear leg 15 is pivotally supported via a pivot shaft 19a as the shaft portion provided between the two sidewall portions. The upper end of the front leg 13 is placed between the two sidewall portions, and is fixed to the central coupling member 19. When the stroller 11 is in the deployed state, the front leg 13 and the rear leg 15, each extending linearly, are held at a predetermined angle therebetween by a deployed-state lock mechanism, not shown. As described in detail below, in the folding operation of the stroller 11, the rear leg 15 pivots about the pivot shaft 19a to a folded position.

The slide member 20 is slidably coupled to the central coupling member 19. The slide member 20 is a linear pipe extending along the front leg 13, and is included in the front-leg member. A dovetail groove 20g is formed in the slide member 20 so that the dovetail portion of the central coupling member 19 fits in the dovetail groove 20g. As shown in FIG. 2, when the stroller 11 is in the deployed state, a lower end region of the slide member 20 adjoins an intermediate region of the front leg 13 so as to overlap the intermediate region of the front leg 13. An upper end region of the slide member 20 protrudes upward beyond the upper end of the front leg 13 to support a canopy 23. As described in detail below, in the folding operation of the stroller 11, the slide member 20 slides downward to a folded position.

The push bar 21 is a linear pipe extending obliquely in the vertical direction. In this embodiment, the pair of push bars 21 are provided on the left and right sides in the lateral direction, respectively. A handle portion 25 is attached to the upper ends of the pair of push bars 21 to couples the upper ends of the push bars 21 together. The push bar 21 is pivotally attached to the slide member 20 of the frame main body 16 via a pivot shaft 21a provided above the lower end of the push bar 21.

As shown in FIGS. 1 and 2, when the stroller 11 is in the deployed state, the pivot shaft 21a is located near the central coupling member 19. The central coupling member 19 couples the upper end of the front leg 13 to the upper end of the rear leg 15, the front leg 13 and the rear leg 15 have substantially the same length, the front leg 13 extends forward and downward from the central coupling member 19 at a predetermined angle, and the rear leg 15 extends rearward and downward from the central coupling member 19 at the same predetermined angle as the front leg 13. Thus, the front leg 13 and the rear leg 15 forms an isosceles triangle in the side views of FIGS. 1 and 2.

The push bar 21 is pivotable in the longitudinal direction about the pivot shaft 21a, and is switched between the forward-facing position shown in FIG. 1 and the rear-facing position shown in FIG. 2.

When the push bar 21 is located at the forward-facing position (FIG. 1), the lower end of the push bar 21 extends downward and forward along the front leg 13, and the upper end of the push bar 21 extends upward and rearward. Thus, the handle portion 25 located on the rear-leg side of the stroller 11 is located at an appropriate height position for an adult operator of the stroller 11 who has an average height. This allows the operator to easily push the stroller 11 while holding the handle portion 25 with his/her hands. The handle portion 25 is separated rearward from the rear wheels 14 at an appropriate longitudinal distance so that the front leg of the operator does not interfere with the rear wheels 14 when the operator is walking while pushing the stroller 11 with his/her hands.

When the push bar 21 is located at the rear-facing position (FIG. 2), the lower end of the push bar 21 extends downward and rearward along the rear leg 15, and the upper end of the push bar 21 extends upward and forward. Thus, even in the rear-facing mode, the handle portion 25 located on the front-leg side of the stroller 11 is located at an appropriate height position for the adult operator of the stroller 11 who has an average height. This allows the operator to easily push the stroller 11 while holding the handle portion 25 with his/her hands. Even in the rear-facing mode, the handle portion 25 is separated forward from the front wheels 12 at an appropriate longitudinal distance so that the front leg of the operator does not interfere with the front wheels 12 when the operator is walking while pushing the stroller 11 with his/her hands.

In the present embodiment, the pivot shaft 21a of the push bar 21 is placed in a longitudinal central portion of the frame main body 16. Thus, the pivot shaft 21a is located at an intermediate position between the front wheel 12 and the rear wheel 14. More specifically, the pivot shaft 21a is located approximately on the perpendicular bisector of a phantom line connecting the front wheel 12 to the rear wheel 14 and extending horizontally in the longitudinal direction, as viewed from the lateral side of the stroller 11. The push bar 21 in the forward-facing position and the push bar 21 in the rear-facing position are approximately symmetrical with respect to this perpendicular bisector. Thus, the handle portion 25 is located approximately at the same height position both in the forward-facing position and the rear-facing position. Moreover, the longitudinal distance from the handle portion 25 in the forward-facing position to the rear wheel 14 is approximately equal to the longitudinal distance from the handle portion 25 in the rear-facing position to the front wheel 12.

This allows the push bars 21 to be located at an optimal position for the operator not only when the push bars 21 are located in the forward-facing position, but also when the push bars 21 are switched to the rear-facing position. This makes it easier for the operator to push the stroller 11 not only in the forward-facing mode but also in the rear-facing mode.

An engaging unit will be described below. The engaging unit selectively engages the lower end of the push bar 21, namely a portion of the push bar 21 which is located below the pivot shaft 21a, with either a portion of the frame main body 16 which adjoins the front leg 13 or the rear leg 15.

The stroller 11 includes a push-bar lock mechanism 41 as the engaging unit that engages the lower end of the push bar 21 with the frame main body 16 or the rear leg 15. The push-bar lock mechanism 41 has a protruding member 42 provided on the slide member 20 of the frame main body 16, a protruding member 43 provided on the rear leg 15, and an engaging member 44 displaceably provided on the lower end of the push bar 21 to selectively engage with the protruding member 42 or 43.

When the push bar 21 is in the forward-facing position as shown in FIG. 1, the engaging member 44 engages with the protruding member 42 as an engaged member provided on the frame main body 16. Thus, the lower end of the push bar 21 is engaged with the portion of the frame main body 16 which adjoins the front leg 13, so that the push bar 21 is held in the forward-facing position. When the push bar 21 is in the rear-facing position as shown in FIG. 2, the engaging member 44 engages with the protruding member 43 as an engaged member provided on the rear leg 15. Thus, the lower end of the push bar 21 is engaged with the rear leg 15, so that the push bar 21 is held in the rear-facing position.

The slide member 20, the front leg 13, and the rear leg 15 are located at the same position in the lateral direction of the stroller 11, and the push bar 21 is located laterally outside the slide member 20, the front leg 13, and the rear leg 15. This allows the lower end of the push bar 21 to pivot without interfering with the slide member 20, the front leg 13, and the rear leg 15. The push-bar lock mechanism 41 is provided on the laterally outer side with respect to the slide member 20 and the rear leg 15, and on the laterally inner side with respect to the push bar 21.

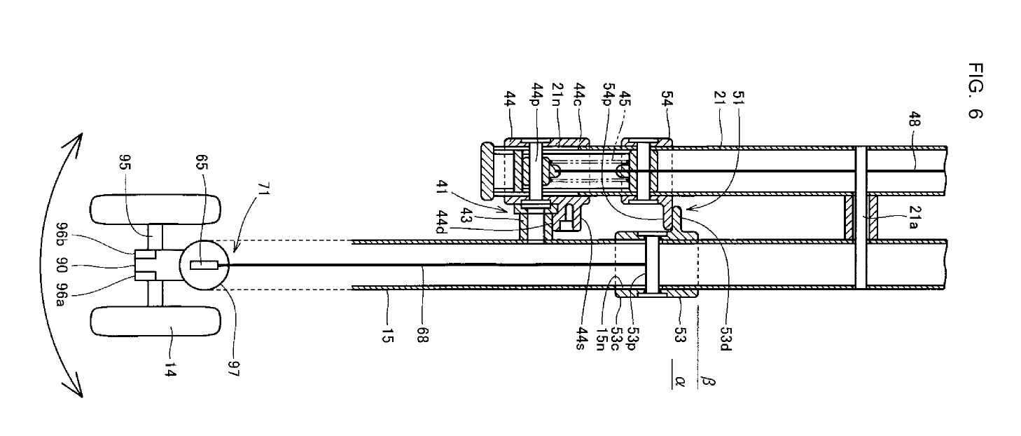

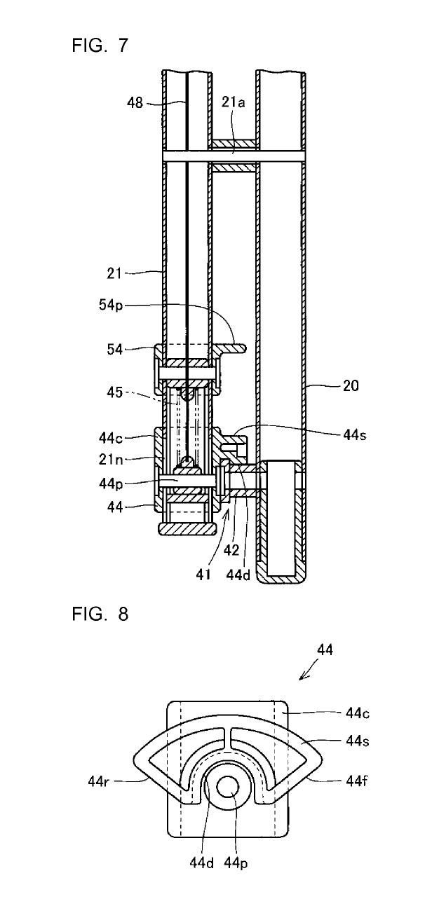

FIG. 5 is a side view of the push-bar lock mechanism 41 as viewed from laterally outside, showing the push-bar lock mechanism 41 in the state in which the push bar 21 is being switched from the rear-facing position to the forward-facing position or vice versa. FIG. 6 is a front view showing the push-bar lock mechanism 41 that holds the push bar 21 in the rear-facing position. FIG. 7 is a front view showing the push-bar lock mechanism 41 that holds the push bar 21 in the forward-facing position. The left side in FIGS. 6 and 7 shows the laterally outer side, and the right side in FIGS. 6 and 7 shows the laterally inner side. FIG. 8 is an illustration showing the engaging member 44 of the push-bar lock mechanism 41 as viewed from laterally inside. The protruding member 42 protrudes laterally outward from the lower end of the slide member 20. The protruding member 43 protrudes laterally outward from a central portion of the rear leg 15. The protruding members 42, 43 have a larger diameter at its tip end (on the laterally outer side) than at its root (on the laterally inner side). The engaging member 44 has a cylindrical portion 44c that opens at both ends to allow the push bar 21 to be inserted therethrough, and a fan-shaped portion 44s protruding laterally inward from the cylindrical portion 44c.

A pin 44p is provided across the inner periphery of the cylindrical portion 44c. The pin 44p engages with a long hole 21n that is formed in the push bar 21 to extend in the direction in which the push bar 21 extends. The engaging member 44 can be guided by the long hole 21n to slide by a predetermined distance along the push bar 21. The engaging member 44 thus displaces in a direction perpendicular to the direction in which the push bar 21 pivots about the pivot shaft 21a. The pin 44p is biased downward by an elastic member 45 provided in a contracted state within the push bar 21. Thus, the engaging member 44 is normally located at a lower first position. The engaging member 44 is displaced in the direction in which the push bar 21 extends, thereby temporarily moving to an upper second position to engage with or disengage from the protruding member 42, 43.

The fan-shaped portion 44s has a fan shape that becomes wider toward the pivot shaft 21a as viewed from the lateral side of the stroller 11. The fan-shaped portion 44s has a tilted surface 44f on the front side, and a tilted surface 44r on the rear side. A cutout portion 44d that receives the protruding member 42, 43 is formed on the lower side of the fan-shaped portion 44s, where the upper side of the fan-shaped portion 44s is the side located closer to the pivot shaft 21a, and the lower side of the fan-shaped portion 44s is the side located away from the pivot shaft 21a. The cutout portion 44d opens inward in the lateral direction of the stroller 11, and is formed by cutting out the fan-shaped portion 44s from the bottom contour of the fan shape. The cutout portion 44d has a relatively small groove width on its outer side (on the laterally inner side) and has a relatively large groove width on its inner side (on the laterally outer side) so as to correspond to the shape of the protruding member 42, 43 having a larger diameter at its tip end than at its root.

The fan-shaped portion 44s having a fan shape as viewed laterally has a continuous contour in the order of the tilted surface 44f, the cutout portion 44d, and the tilted surface 44r. This allows the protruding member 42 to slide-contact the fan-shaped portion 44s from the tilted surface 44f to the cutout portion 44d, and to fit in the cutout portion 44d. This also allows the protruding member 43 to slide-contact the fan-shaped portion 44s from the tilted surface 44r to the cutout portion 44d, and to fit in the cutout portion 44d.

As shown by solid line in FIG. 5, when the push bar 21 is switched from the forward-facing position to the rear-facing position, the tilted surface 44r first comes into contact with the protruding member 43. The protruding member 43 then slide-contacts the tilted surface 44r and moves toward the lower side of the tilted surface 44r while displacing the engaging member 44 to a position above the first position against the elastic member 45. Then, when the protruding member 43 passes the tilted surface 44r and reaches the cutout portion 44d, the engaging member 44 is returned to the first position by the elastic member 45, and the protruding member 43 fits in the cutout portion 44d. The engaging member 44 engages with the protruding member 43 in this manner. As shown by two-dotted line in FIG. 5, the protruding member 42 contacts and slide-contacts the tilted surface 44f in a manner similar to that described above.

In order to disengage the protruding member 42 or 43 from the engaging member 44, the engaging member 44 can be lifted to a position above the first position against the elastic member 45.

For this purpose, the push bar 21 is provided with a push-bar unlock unit 46. The push-bar unlock unit 46 has a pair of cylindrical movable members 47 respectively attached to the upper ends of the pair of push bars 21 and each capable of sliding on the push bar 21 by a predetermined distance in the longitudinal direction of the push bar 21, and a pair of wires 48 each provided within the push bar 21 to couple the movable member 47 to the engaging member 44. The lower end of the wire 48 is coupled to the pin 44p. When the operator lifts the movable member 47, the engaging member 44 is lifted to a position above the first position via the wire 48. Thus, the protruding member 42, 43 is removed from the cutout portion 44d, allowing the push bar 21 to pivot.

As described above, according to the push-bar lock mechanism 41 of the present embodiment, the lower end of the push bar 21, namely the portion of the push bar 21 which is located below the pivot shaft 21a, is engaged with the frame main body 16 or the rear leg 15. This can reduce the force that is applied to the frame main body 16 as compared to the conventional reversible strollers in which the push bar is engaged with the armrest of the frame main body at a position above the pivot shaft of the push bar. Thus, backlash of the frame main body 16 is prevented, and rigidity is improved. Moreover, the force that is applied to the frame main body 16 during the lifting operation can be reduced.

According to the push-bar lock mechanism 41 of the present embodiment, the engaging member 44 automatically engages with the protruding member 42, 43 due to the function of the fan-shaped portion 44s by merely shifting the push bar 21 to the forward-facing position or the rear-facing position. This facilitates handling of the stroller 44.

In addition to the push-bar lock mechanism 41 of the present embodiment, the protruding member 42 of the push-bar lock mechanism 41 may be provided on the front leg 13 rather than on the slide member 20 in a modification, not shown. Since the slide member 20 and the front leg 13 are included in the front-leg member, the lower end of the push bar 21 can be selectively engaged with either the front-leg member or the rear-leg member even in such a modification.

As another modification, the pivot shaft 21a may be provided in the upper end of the rear leg 15 or in the rear-leg member including the rear leg 15. As still another modification, the protruding member 43 may be provided on the rear-leg member. As a further modification, the pivot shaft 21a may be provided in the frame main body 16, e.g., in the central coupling member 19. Even in such modifications, the lower end of the push bar 21 can be selectively engaged with the front-leg member or the rear-leg member.

All of the pair of front wheels 12 and the pair of rear wheels 14 are casters each capable of pivoting about a rotation axis Xf or Xr extending in the vertical direction as shown by one-dotted chain line in FIGS. 1 and 2. Thus, using the casters as the wheel units of the stroller 11 allows the moving direction of the stroller 11 to be switched to the forward-facing direction (FIG. 1) or the rear-facing direction (FIG. 2) by merely switching the push bar 21 of the stroller 11 to the position of FIG. 1 or the position of FIG. 2, and thus allows the stroller 11 to be moved in any direction.

However, using the casters as the four wheels of the stroller 11 results in a meandering traveling track of the stroller 11. In order to prevent such meandering, the rotating operation of the wheels located on the rear side in the traveling direction of the stroller 11 need be prohibited. In the present embodiment, the stroller 11 has a front-caster lock mechanism 61 and a rear-caster lock mechanism 71 as mechanisms that prevent rotation of the casters located on the rear side in the traveling direction of the stroller 11.

First, front and rear-caster mechanisms will be described.

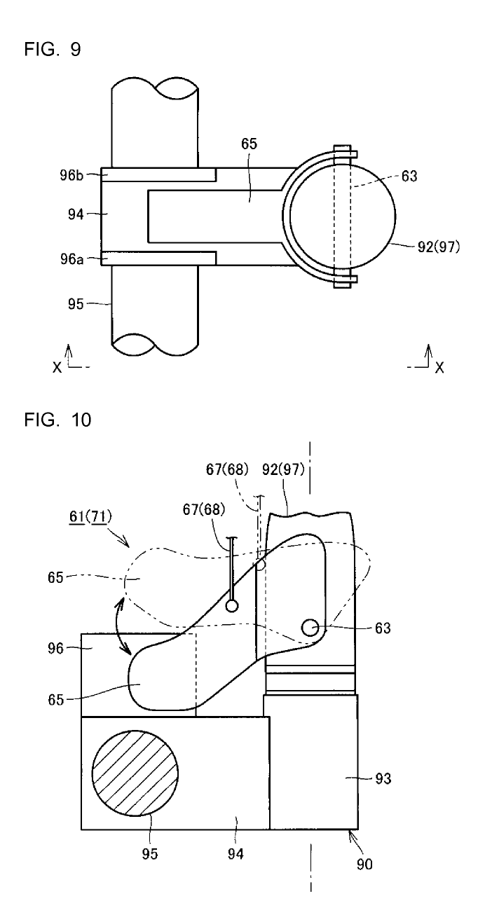

FIG. 9 is a schematic view showing a front or rear caster as viewed from above. FIG. 10 is a schematic view showing the front or rear caster as viewed laterally. A caster holding member 92 is fixed to the lower end of the front end 13. The caster holding member 92 pivotally holds a caster pivot member 90. The caster pivot member 90 includes a yoke 93 having its upper end pivotally coupled to the caster holding member 92, a support portion 94 protruding in a direction perpendicular to the rotation axis of the caster pivot member 90 shown by one-dotted chain line in FIG. 10, and an axle 95 shaft-supported by the support portion 94. The axle 95 extends in the horizontal direction, and has its central portion shaft-supported by the support portion 94, and the front wheels 12 are attached to both ends of the axle 95, respectively. A pair of pivot stop members 96 (96a, 96b) are formed in an upper part of the support portion 94.

The rear-caster mechanism is configured similarly, and a caster holding member 97 is fixed to the lower end of the rear leg 15. The caster holding member 95 pivotally holds the caster pivot member 90.

The front and rear-caster lock mechanisms will be described below.

The front-caster lock mechanism 61 includes a front-caster lock member 65 that is pivotally held by the caster holding member 92 via a pin 63. The position of the front-caster lock member 65 can be changed by a wire 67 having its lower end connected to the front-caster lock member 65. By reducing the tensile force of the wire 67, the front-caster lock member 65 moves about the pin 63 in the downward direction of an arrow shown in the figure and reaches a first position shown by solid line in the figure. Thus, the front-caster lock member 65 enters between the pair of pivot stop members 96a, 96b to prevent the direction of the axle 95 from being changed by the caster pivot member 90. On the other hand, by increasing the tensile force of the wire 67, the front-caster lock member 65 moves about the pin 63 in the upward direction of the arrow shown in the figure, and is separated from the caster pivot member 95 and reaches a second position shown by two-dotted chain line in the figure. In this state, the direction of the axle 95 can be changed to any direction by the caster pivot member 90.

Although not shown in the figure, the front-caster lock member 65 is provided with a spring that biases the front-caster lock member 65 in the downward direction of the arrow shown in FIG. 10. Thus, if the tensile force of the wire 67 is larger than the biasing force of the spring, the front-caster lock member 65 is located at the second position. If the tensile force of the wire 67 is smaller than the biasing force of the spring, the front-caster lock member 65 is located at the first position. The front wheel 12 is directed straight in the longitudinal direction of the stroller 11 so as not to turn leftward or rightward.

Referring to FIG. 10, the rear-caster lock mechanism 71 includes the rear-caster lock member 65 that is pivotally held by the caster holding member 97 via the pin 63. Since the rear-caster lock mechanism 71 is configured in a manner similar to that of the front-caster lock mechanism 61, detailed description of the rear-caster lock mechanism 71 will be omitted.

Thus, change in direction of the rear wheel 14 is restricted when the rear-caster lock member 65 is not lifted via a wire 68 provided within the rear leg 15 and having its lower end connected to the rear-caster lock member 65. If the wire 68 lifts the rear-caster lock member 65 against the biasing force of the spring, not shown, the rear-caster lock member 65 is removed from between the pair of pivot stop members 96a, 96b to allow the rear wheel 14 to change its direction.

The front and rear-caster lock mechanisms 61, 71 operate together with the push bar 21. As described below, the front and rear-caster lock mechanisms 61, 71 allow the wheels located on the front side in the traveling direction to change their directions, and restrict change in direction of the wheels located on the rear side in the traveling direction, according to the forward-facing mode or the rear-facing mode.

The stroller 11 has, in addition to the push-bar lock mechanism 41, an engaging unit 51 that selectively engages the lower end of the push bar 21, namely the portion of the push bar 21 which is located below the pivot shaft 21a, with either the front leg 13 or the rear leg 15. The engaging unit 51 includes a push-bar member 54 provided on the lower end of the push bar 21, a front-leg-side movable member 52 that is displaceably provided on the front leg 13 and that engages with the push-bar member 54 when the push bar 21 is shifted to the forward-facing position, and a rear-leg-side movable member 53 that is displaceably provided on the rear leg 15 and that engages with the push-bar member 54 when the push bar 21 is shifted to the rear-facing position.

The front-leg-side movable member 52 has a cylindrical portion 52c opening at its both ends, and a ridge 52d protruding outward in the lateral direction of the stroller 11 from the outer peripheral surface of the cylindrical portion 52c. The cylindrical portion 52c has a central portion of the front leg 13 inserted therethrough. A pin 52p is provided across the inner periphery of the cylindrical portion 52c. A long hole 13n extending in the longitudinal direction of the front leg 13 is formed in the front leg 13. The pin 52p extends through the long hole 13n. Thus, the front-leg-side movable member 52 is displaceably attached to the front leg 13, and is displaceable between a lower first position α and an upper second position β.

The ridge 52d extends in the longitudinal direction of the stroller 11. The ridge 52d excluding its front end is tilted upward from its central portion toward its rear end. The vertical dimension of the ridge 52d corresponds to the amount by which the front-leg-side movable member 52 moves in the vertical direction, and the front-leg-side movable member 52 is capable of engaging with the push-bar member 54 while moving upward.

The front-leg-side movable member 52 is biased to the lower first position α by an elastic member, not shown. When the push bar 21 is not located at the forward-facing position, the front-leg-side movable member 52 is separated and disengaged from the push-bar member 54, and is shifted to the lower first position α as shown in FIG. 2. When the push bar 21 is shifted to the forward-facing position, the front-leg-side movable member 52 engages with the push-bar member 54, and is shifted to the upper second position β as shown in FIG. 1.

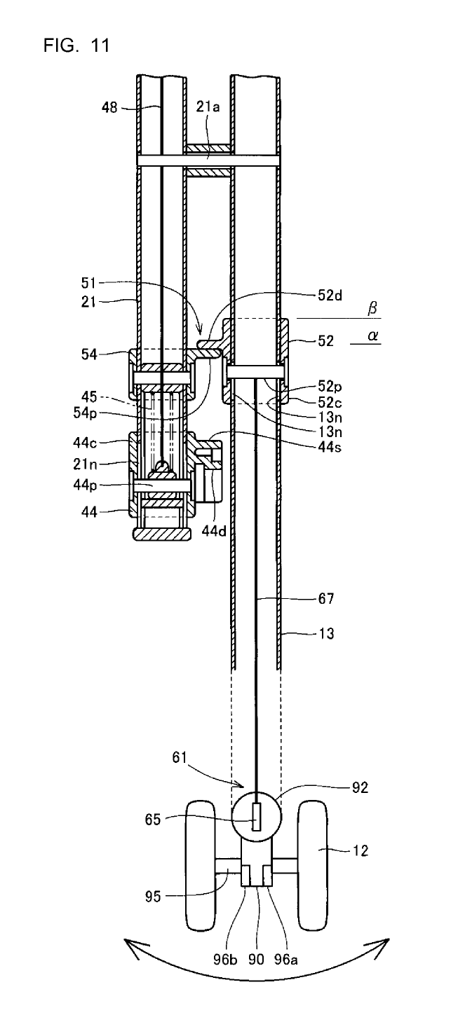

FIG. 11 is a front view corresponding to FIG. 7, showing the front leg 13 and the front-caster lock mechanism 61. As shown in FIG. 11, the pin 52p is connected to the upper end of the wire 67 provided within the front leg 13. The wire 67 is included in a front-leg link mechanism that connects the front-caster lock member 65 to the front-leg-side movable member 52 of the engaging unit 51, and the lower end of the wire 67 is connected to the front-caster lock member 65. The push-bar member 54 has a protrusion 54p protruding inward in the lateral direction of the stroller 11 and rearward. When the push bar 21 is shifted to the forward-facing position, the protrusion 54p contacts the lower surface of the ridge 52d. As the lower end of the push bar 21 pivots forward about the pivot shaft 21a, the protrusion 54p engages with the ridge 52d so as to slide-contact the ridge 52d from the rear end toward the front end of the ridge 52d, and pushes the front-leg-side movable member 52 upward. Thus, the front-leg-side movable member 52 is shifted to the upper second position β. Accordingly, the wire 67 lifts the front-caster lock member 65 to the second position. The front-caster lock member 65 is separated from the caster pivot member 90 to allow the caster pivot member 90 to pivot.

Since the protrusion 54p protrudes not only laterally inward but also rearward, the push-bar member 54 can engage with the front-leg-side movable member 52 even if the push bar 21 is located forward of the front leg 13 when in the forward-facing position.

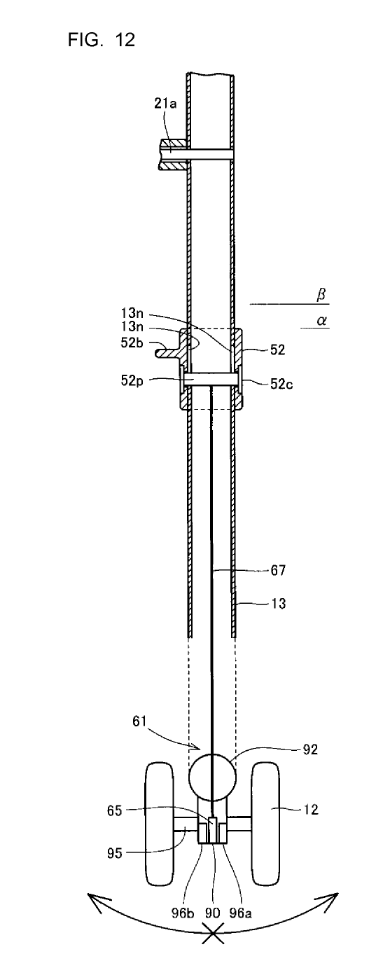

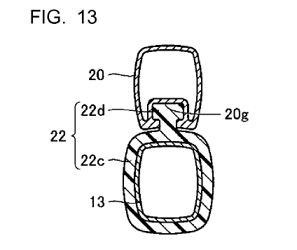

For comparison with FIG. 11, FIG. 12 shows a front view of the front leg 13 and the front-caster lock mechanism 61 in the case where the push bar 21 is not located at the forward-facing position. As described above, if the push bar 21 is not located at the forward-facing position, the front-leg-side movable member 52 does not engage with the push-bar member 54. Thus, the front-leg-side movable member 52 is biased downward to the first position α by the elastic member, not shown. The front-caster lock member 65 returns to the lower first position, and engages with the caster pivot member 90 to restrict pivoting of the caster pivot member 90.

The rear-leg-side movable member 53 is configured in a manner similar to that of the front-leg-side movable member 52, and has a cylindrical portion 53c opening at its both ends and having the rear leg 15 inserted therethrough, a ridge 53d protruding outward in the lateral direction of the stroller 11 from the outer peripheral surface of the cylindrical portion 53c, and a pin 53p extending through a long hole 15n in the rear leg 15. The ridge 53d extends in the longitudinal direction of the stroller 11. The ridge 53d excluding its rear end is tilted upward from its central portion toward its front end. The vertical dimension of the ridge 53d corresponds to the amount by which the rear-leg-side movable member 53 moves in the vertical direction, and the rear-leg-side movable member 53 is capable of engaging with the push-bar member 54 while moving upward. Like the front-leg-side movable member 52, the rear-leg-side movable member 53 is displaceable between the lower first position α and the upper second position β. When the push bar 21 is not located at the rear-facing position, the rear-leg-side movable member 53 is biased downward to the lower first position α by an elastic member, not shown. When the push bar 21 is located at the rear-facing position, the rear-leg-side movable member 53 is shifted to the upper second position β.

The pin 53p is connected to the upper end of the wire 68, and the rear-caster lock member 65 is connected to the lower end of the wire 68. The rear-caster lock member 65 operates according to displacement of the rear-leg-side movable member 53 by the wire 68 included in a rear-wheel link mechanism that connects the rear-caster lock member 65 to the rear-leg-side movable member 53 of the engaging unit 51.

Thus, the front-caster lock mechanism 61 operates according to whether the push bar 21 is located at the forward-racing position or the rear-facing position, and allows the front wheel 12 located on the front side in the traveling direction to change its direction when the push bar 21 is located at the forward-facing position. The rear-caster lock mechanism 71, which is configured in a manner similar to that of the front-caster lock mechanism 61, also operates according to whether the push bar 21 is located at the forward-facing position or the rear-facing position, and restricts change in direction of the rear wheel 14 located on the rear side in the traveling direction, when the push bar 21 is located in the forward-facing position.

In this manner, the front and rear⁻caster lock mechanisms 61, 71 allow the front wheel 12 to change its direction, and restrict change in direction of the rear wheel 14, while the push bar 21 is located at the forward-facing position.

While the push bar 21 is located at the rear-facing position, the front and rear-caster lock mechanisms 61, 71 allow the rear wheel 14 located on the front side in the traveling direction to change its direction, and restrict change in direction of the front wheel 12 located on the rear side in the traveling direction. Thus, regardless of whether the push bar 21 is located at the forward-facing position or the rear-facing position, change in direction of the wheel located on the rear side in the traveling direction of the stroller 11 is prohibited, and only the wheel located on the front side in the traveling direction of the stroller 11 is allowed to change its direction.

The stroller 11 can be folded into a compact folded configuration when not in use. The folding operation of the stroller 11 will be described below.

The stroller 11 further includes a pair of longitudinal members 27 that are placed between the slide member 20 and the rear legs 15. The longitudinal member 27 extends substantially in the longitudinal direction of the stroller 11, has its front end coupled to the lower end of the slide member 20 via a pivot shaft 20a, and has its rear end coupled to a lower end region of the rear leg 15 via a pivot shaft 15a.

A slide bracket 22 is fixed to a central portion of the front leg 13. FIG.

13 shows a cross-sectional view of the slide bracket 22 and other members taken along one-dotted chain line XIII-XIII in FIG. 2, as viewed from the direction of arrows of the chain line XIII-XIII. The slide bracket 22 has a cylindrical portion 22c opening at its both ends, and a dovetail protruding portion 22d protruding from the outer periphery of the cylindrical portion 22c. The front leg 13 is inserted through the cylindrical portion 22c. A pin 22p extending in the lateral direction of the front leg 13 extends through the cylindrical portion 22c and the front leg 13 to fix the cylindrical portion 22c and the front leg 13 together. The dovetail groove 20g is formed in the slide member 20 so as to extend in the longitudinal direction of the slide member 20, and the protruding portion 22d slidably and inseparably fits in the dovetail groove 20g.

A similar dovetail portion is formed in the central coupling member 19, and the dovetail portion of the central coupling member 19 slidably and inseparably fits in the dovetail groove 20g. Thus, the slide member 20 is coupled to the front leg 13 at two positions via the central coupling member 19 and the slide bracket 22 which are separated from each other in the longitudinal direction of the slide member 20. Since the stroller 11 is held in the deployed state shown in FIGS. 1 and 2 by a deployed-state holding unit, not shown, the slide member 20 does not slide along the front leg 13 unless the deployed-state holding unit is released.

The folding operation of the stroller 11 is started in the forward-facing mode in which the push bar 21 extends along the slide member 20. With the front wheel 12 being directed straight in the longitudinal direction of the stroller 11 at a position rearward of the rotation axis Xf and with the rear wheel 14 being directed straight in the longitudinal direction of the stroller 11 at a position rearward of the rotation axis Xr as shown in FIG. 1, the deployed-state holding unit, not shown, which holds the stroller 11 in the deployed state is released, and the push bar 21 is pushed down. Thus, the push bar 21 together with the slide member 20 slides downward along the front leg 13, and the stroller 11 is deformed to a state in the folding process as shown in FIG. 3. The rear leg 15 coupled to the slide member 20 via the longitudinal member 27 pivots forward about the pivot shaft 19a provided in the upper end of the rear leg 15. It can be understood from FIG. 3 that, by the folding operation, the vertical dimension of the stroller 11 is reduced because the lower end of the slide member 20 together with the lower end of the push bar 21 slides downward beyond the lower end of the front leg 13, and the longitudinal dimension of the stroller 11 is reduced because the rear wheel 14 moves closer to the front wheel 12.

The protrusion 54p of the push-bar member 54 contacts the lower surface of the ridge 52d when the push bar 21 is located at the forward-facing position. Accordingly, the engaging unit 51 does not hinder the folding operation of the stroller 11.

If the push bar 21 is further pushed down, the slide member 20 together with the push bar 21 slides further downward, the rear leg 15 pivots further forward about the pivot shaft 19a, and the rear wheel 14 moves much closer to the front wheel 12. In this manner, as shown in FIG. 4, the push bar 21 is shifted to a folded position, and the rear leg 15 is also shifted to a folded position, whereby the stroller 11 is folded. Although the stroller 11 has a reduced longitudinal dimension in this state, the stroller 11 stands by itself on a flat ground surface G. This is because, in the folded state, the lower end of the slide member 20 contacts the ground surface G on the front side of the stroller 11, and the rear wheel 14 contacts the ground surface G on the rear side of the stroller 11. Namely, in the folded state, the center of gravity of the stroller 11 is located between the lower end of the slide member 20 and the rear wheel 14.

In the present embodiment, as shown in FIG. 4, the stroller 11 stands by itself in the folded state with the lower end of the slide member 20 and the rear wheel 14 being in contact with the ground surface G, as viewed laterally. Although not shown in the figure, the lower end of the push bar 21 may contact the ground surface G instead of the slide member 20, or both the lower end of the slide member 20 and the lower end of the push bar 21 may contact the ground surface G. The front wheel 12 may contact the ground surface G instead of the rear wheel 14 so that the center of gravity of the stroller 11 in the folded state is located between the lower end of the slide member 20 and the front wheel 12.

Since the push bar 21 together with the slide member 20 slides downward, the push-bar member 54 on the lower end of the push bar 21 is disengaged from both the front-leg-side movable member 52 and the rear-leg-side movable member 53. This restricts change in direction of both the front wheel 12 and the rear wheel 14. Accordingly, when the stroller 11 is in the folded state, the front wheel 12 and the rear wheel 14 do not accidentally rotate, and both the front wheel 12 and the rear wheel 14 are held to be directed straight in the longitudinal direction of the stroller 11. This allows the stroller 11 to stand by itself more stably.

Although the embodiment of the present invention is described above with reference to the drawings, the present invention is not limited to the illustrated embodiment. Various modifications and variations can be made to the illustrated embodiment without departing from the sprit and scope of the present invention. For example, although the longitudinal member 27 is attached laterally inside the slide member 20 and the rear leg 15, the longitudinal member 27 may be attached laterally outside the slide member 20 and the rear leg 15.

The stroller according to the present invention is advantageously used in nursery equipment including a push bar capable of being switched between a rear-facing mode and a forward-facing mode.

1. A stroller, comprising:
a pair of front-leg members each having a front wheel at its lower end;
a pair of rear-leg members each having a rear wheel at its lower end;
a frame main body that couples an upper end of said front-leg member to an upper end of said rear-leg member;
a push bar extending in a vertical direction, attached to said frame main body, said front-leg member, or said rear-leg member via a pivot shaft at a position above a lower end of said push bar, and capable of being selectively switched between a forward-facing position and a rear-facing position by pivoting about said pivot shaft in a longitudinal direction of said stroller; and
an engaging unit that selectively engages a lower end region of said push bar, namely a portion of said push bar which is located below said pivot shaft, with said front-leg member or said rear-leg member.

2. The stroller according to claim 1, wherein
said engaging unit includes a push-bar lock mechanism that engages said lower end of said push bar with said front-leg member to hold said push bar in said forward-facing position, and that engages said lower end of said push bar with said rear-leg member to hold said push bar in said rear-facing position.

3. The stroller according to claim 2, wherein
said push-bar lock mechanism has an engaging member provided on said lower end of said push bar and capable of being displaced in a direction in which said push bar extends, and an engaged member provided on each of said front-leg member and said rear-leg member to engage with said engaging member.

4. The stroller according to claim 1, wherein
said engaging unit includes a push-bar member provided on said lower end of said push bar, a front-leg-side movable member that is displaceably provided on said front-leg member and that engages with said push-bar member when said push bar is shifted to said forward-facing position, and a rear-leg-side movable member that is displaceably provided on said rear-leg member and that engages with said push-bar member when said push bar is shifted to said rear-facing position,
said front wheel and said rear wheel are casters capable of changing their directions, said stroller further comprising:
a front-caster mechanism having a caster holding member that is provided on said lower end of said front-leg member, and a caster pivot member that is held by said caster holding member so as to be pivotable about a rotation axis extending in said vertical direction and that shaft-supports said front wheel;
a rear-caster mechanism having a caster holding member that is provided on said lower end of said rear-wheel member, and a caster pivot member that is held by said caster holding member so as to be pivotable about a rotation axis extending in said vertical direction, and that shaft-supports said rear wheel;
a front-caster lock mechanism having a front-caster lock member that is provided on said caster holding member of said front wheel, and that, when located at a first position, engages with said caster pivot member of said front wheel to restrict pivoting of said caster pivot member, and when located at a second position, is separated from said caster pivot member of said front wheel to allow said caster pivot member to pivot;
a rear-caster lock mechanism having a rear-caster lock member that is provided on said caster holding member of said rear wheel, and that, when located at a first position, engages with said caster pivot member of said rear wheel to restrict pivoting of said caster pivot member, and when located at a second position, is separated from said caster pivot member of said rear wheel to allow said caster pivot member to pivot;
a front-leg link mechanism that connects said front-caster lock member with said front-leg-side movable member of said engaging unit; and
a rear-leg link mechanism that connects said rear-caster lock member with said rear-leg-side movable member of said engaging unit.

5. The stroller according to claim 1, wherein
said front-leg member includes a front leg having said front wheel at its lower end, and a slide member attached so as to be slidable along said front leg, and
said push bar is attached to said slide member via a pivot shaft, and is shifted to a folded position by sliding downward from said forward-facing position.

6. The stroller according to claim 4, wherein
said front-leg member includes a front leg having said front wheel at its lower end, and a slide member attached so as to be slidable along said front leg, and
said push bar is attached to said slide member via a pivot shaft, and said push bar is shifted to a folded position by sliding downward from said forward-facing position, and said push-bar member of said engaging unit is disengaged from both said front-leg-side movable member and said rear-leg-side movable member.

7. The stroller according to claim 5, further comprising:
a longitudinal member extending in said longitudinal direction, having its front end coupled to said slide member via a pivot shaft, and having its rear end coupled to said rear leg via a pivot shaft, and
said rear leg has its upper end coupled to said frame main body via a pivot shaft, and is shifted to a folded position by pivoting forward about said pivot shaft in said upper end of said rear leg.

8. The stroller according to claim 7, wherein
said stroller stands by itself in a folded state with at least one of a lower end of said slide member and said lower end of said push bar in said folded position being in contact with a ground, and with at least one of said front wheel and said rear wheel being in contact with said ground.
